(19) United States
(12) Patent Application Publication
(10) Pub. No.: US 2023/0332451 A1
(43) Pub. Date: Oct. 19, 2023

(54) GUIDED SLIDING DOOR ASSEMBLY AND METHOD OF CONNECTING A DOOR LEAF OF A SLIDING DOOR TO A DOOR GUIDE ASSEMBLY

(71) Applicant: IKEA Supply AG, Pratteln (CH)

(72) Inventor: Tomas ESKILSSON, Hamneda (SE)

(73) Assignee: IKEA Supply AG, Pratteln (CH)

(21) Appl. No.: 18/027,289

(22) PCT Filed: Sep. 21, 2021
(86) PCT No.: PCT/SE2021/050905

§ 371 Date: Mar. 20, 2023

(30) Foreign Application Priority Data
Sep. 21, 2020 (SE) 2051098-8

(51) Int. Cl. E05F 5/00; E05D 15/06

(52) U.S. Cl. CPC E05F 5/003; E05D 15/0691; E05D 15/0665; E05Y 2600/456; E05Y 2600/46; E05Y 2900/132

(57) ABSTRACT

A sliding door assembly includes: a door guide (20a) extending along a horizontal guide axis (G1); a first door (12a) guided by the door guide (20a); and a second door (12b) guided by the door guide (20a) independently of the first door (12a), wherein the second door (12b) comprises a first-end door coupler (32b) which interfaces in a direction towards a first guide end (16a) of the door guide (20a); and the first door (12a) comprises a second-end door coupler (34a) which interfaces in a direction towards a second guide end (16b) of the door guide (20a) to couple to the first-end door coupler (32b) of the second door, wherein the first- and second-end door couplers (32b, 34a) together define a soft-closing mechanism configured to gradually brake a relative motion between the first and second doors (12a, 12b).

### FIELD OF THE INVENTION

The present invention relates to a guided sliding door assembly, and to a method of connecting a door leaf of a sliding door to a door guide assembly.

### BACKGROUND

WO17036795 A1 discloses a sliding door assembly provided with an arrangement for positioning two sliding doors in relation to one another or in an open position. There is however a need for a more versatile sliding door assembly which can be adapted and used for a greater range of situations.

### SUMMARY

It is an object of the present invention to solve, or at least mitigate, parts or all of the above mentioned problems. To this end, according to a first aspect, there is provided a guided sliding door assembly comprising a door guide assembly configured to define a first door guide extending along a horizontal guide axis from a first guide end to a second guide end; and a first door arrangement assembly comprising a respective first door assembly configured to define a first door guided by said first door guide to be guidedly movable along the guide axis, the first door extending in a vertical door plane along the guide axis; and a respective second door assembly configured to define a second door guided by said first door guide to be guidedly movable along the guide axis independently of said first door, the second door extending in a vertical door plane along the guide axis, wherein the first door comprises a second-end door coupler which interfaces in a direction towards the second guide end of the door guide, the second-end door coupler of said first door being configured to couple to said second door, and the second door comprises a first-end door coupler which interfaces in a direction towards the first guide end of the door guide, the first-end door coupler of said second door being configured to couple to said second-end door coupler of said first door, wherein the second-end door coupler of the first door and the first-end door coupler of the second door define a soft-closing mechanism configured to gradually brake a relative motion between the first and second doors along the guide axis. This provides for a simple and convenient guided sliding door arrangement. In particular, the soft-closing mechanism may be configured to gradually brake a relative motion between the first and second doors when they approach each other along the guide axis. Said first door guide may be defined by a respective guide track, which may be provided in a guide rail. Such a guide rail may be defined by an extruded profile. The first and second doors may be guided in the same guide track, and impact between the doors may be efficiently managed with a minimum of complexity and cost. The door planes of the first and second doors may coincide. According to embodiments, the soft-closing mechanism may be configured to enable said first and second doors to reach a position in which they abut each other.

According to embodiments, the first door may comprise an end-stop coupler which interfaces towards the first guide end of the door guide, and the first guide end of the first door guide may comprise a first guide-end door coupler configured to couple to the end-stop coupler of said first door, wherein the end-stop coupler of said first door and the first guide-end door coupler of the first door guide together define a soft-closing mechanism configured to gradually brake a motion of the first door along the guide axis.

According to embodiments, the second door may comprise a first auxiliary coupler which interfaces towards the second guide end of the door guide, the first auxiliary coupler being configured to couple to a second auxiliary coupler, wherein the first and second auxiliary couplers define a soft-closing mechanism configured to gradually brake a relative motion along the guide axis between the second door and an object carrying the second auxiliary coupler. The auxiliary couplers may define end-stop couplers; i.e. the second auxiliary coupler may be an end-stop coupler fixedly arranged at the second end of said first door guide. Alternatively, the auxiliary couplers may define door couplers; i.e. the second auxiliary coupler may be carried by a third door guided by the first door guide, and guidedly movable along the guide axis independently of the first and second doors.

According to embodiments, the first door may comprise a first-end guide shuttle guided by said first door guide, and a second-end guide shuttle guided by said first door guide.

According to embodiments, the second-end door coupler of said first door may be defined by the second-end guide shuttle of said first door. Alternatively, said first door's second-end door coupler and second-end guide shuttle may be configured as separate devices.

Similarly, according to embodiments, the end-stop coupler of said first door may be defined by the first-end guide shuttle of said first door. Alternatively, the end-stop coupler and the first-end guide shuttle may be configured as separate devices.

According to embodiments, the second door may comprise a first-end guide shuttle guided by said first door guide, and a second-end guide shuttle guided by said first door guide.

According to embodiments, the first-end door coupler of said second door may be defined by the first-end guide shuttle of said second door. Alternatively, second door's first-end door coupler and first-end guide shuttle may be configured as separate devices.

According to embodiments, the first auxiliary coupler of said second door may be defined by the second-end guide shuttle of said second door. Alternatively, the second door's first auxiliary coupler and first-end guide shuttle may be configured as separate devices.

According to embodiments, the first-end door coupler of said second door may define a coupler interface of a first type, and the second-end door coupler of said first door may define a coupler interface of a second type different from the first type. Thereby, the risk of erroneous assembly of the guided sliding door assembly may be reduced. Alternatively, the coupler interfaces of the first- and second-end door couplers may be of the same type. The first and second types may comprise, for example, a self-retractor and a self-retractor activator, or vice versa.

According to embodiments, the end-stop coupler of said first door may define a coupler interface of one of the first and second types, and the first guide-end door coupler may define a coupler interface of the other of the first and second types. By using the same kind of coupler interfaces for the end-stops and the door couplers, the number of different components required for a guided sliding door assembly may be kept low.

According to embodiments, the end-stop coupler of said first door may define a coupler interface of said first type, and the first guide-end door coupler may define a coupler interface of said second type.

According to embodiments, the first auxiliary coupler may be of said first type. Such an arrangement is particularly practical in a configuration wherein the first auxiliary door coupler is an end-stop coupler, wherein end-stop couplers of the first and second doors may be of the same type.

According to embodiments, the coupler interface of the first type may comprise a self-retractor configured to, once having engaged with a coupler interface of the second type, draw itself towards the coupler interface of the second type. The coupler interface of the second type may comprise a self-retractor activator configured to attach to the self-retractor.

According to embodiments, the self-retractor may comprise a main body and a retraction bias element coupled to an activator catcher, and the coupler interface of the second type may comprise a self-retractor activator configured to engage with the activator catcher to release the retraction bias element from a pre-tensioned latch position to draw the self-retractor towards the coupler interface of the second type.

According to some embodiments, the activator catcher may be movable relative to the main body of the self-retractor along the guide axis. Alternatively or additionally, according to embodiments, the activator catcher may be movable against a brake bias relative to the main body of the self-retractor. The brake bias may brake the motion of the first and second doors towards each other, and thereby mitigate the impact between the doors. The brake bias may be generated by a damper.

According to embodiments, the first door may comprise a second-end guide shuttle guided in a shuttle guide track of said first door guide; the second door may comprise a first-end guide shuttle guided in said shuttle guide track; and one of the second-end door coupler of said first door and the first-end door coupler of said second door may comprise a coupler activator guided by a coupler activator guide track adjacent to the shuttle guide track. The coupler activator may be a self-retractor activator as defined hereinabove. According to embodiments, the coupler activator guide track may be open towards the shuttle guide track via an activator gap, which enables the coupler activator to engage with the other of the second-end door coupler of said first door and the first-end door coupler of said second door. The coupler activator guide track may be vertically aligned with the shuttle guide track, such that the coupler activator may run alongside the respective guide shuttle in the same horizontal plane. Such an arrangement is particularly height-efficient.

According to embodiments, the door guide assembly may further comprise a home position connector defining a door home position at an intermediate position between the first and second guide ends, the home position connector being configured to automatically and releasably connect to at least one of said first and second doors when reaching said door home position. Such an arrangement enables positioning the doors in one or several pre-defined positions, for example a closed position, without having to rely on end positions of said first guide. This provides for a particularly versatile guided sliding door assembly. The home position connector may be connectable to e.g. a guide shuttle or to a shuttle connector as defined herein. According to embodiments, the home position connector may be configured to connect to said at least one of the first and second doors by a snap action.

According to embodiments, the home position connector may be configured to connect to said at least one of the first and second doors when said at least one of the first and second doors reaches the home position connector from any direction along said first guide. Similarly, the home position connector may be configured to release said at least one of the first and second doors when said at least one of the first and second doors is pushed away from the home position connector in any disconnection direction along said first guide.

According to embodiments, the home position connector may be configured to automatically release said at least one of the first and second doors when said at least one of the first and second doors is pressed in a direction along the guide axis by a force exceeding a home position release limit force.

According to embodiments, the second-end door coupler of the first door may be configured to, when engaging with the first-end door coupler of the second door, attach to the first-end door coupler of the second door, and to automatically release from the first-end door coupler of the second door when the first and second doors are pressed apart along the guide axis by a disengagement force exceeding a door disengagement limit force, wherein the home position release limit force exceeds the door disengagement limit force, such that the first and second doors can be drawn apart by connecting one of the first and second doors to the home position, and thereafter moving the other of the first and second doors away from the home position. Thereby, re-arrangement of doors is facilitated, since connected doors can be conveniently pulled apart by attaching one of them to a home position, and then pulling the other away from the door held at the home position.

According to embodiments, the home position connector may be repositionable along said guide axis to enable the home position to be axially repositioned. Thereby, the guided sliding door assembly may be particularly easy to adapt to different installation scenarios.

According to embodiments, the guide assembly may define a home position connector guide, and the home position connector may comprise a home position connector clamp configured to clamp the home position connector to the home position guide. Thereby, the home position connector may be clamped to the home position guide at an arbitrary axial position. The home position guide may extend in the same direction as the guide axis. The home position guide may be defined by a guide rail. According to embodiments, said first door guide and the home position connector guide may be defined by different parts of the same guide rail.

According to embodiments, the home position connector guide may be defined by a home position connector guide track, and the home position connector clamp may comprise an elongate clamping element extending in a direction of elongation, wherein the clamping element is insertable, when its direction of elongation extends parallel to the home position connector guide track, into the home position connector guide track in an insertion direction perpendicular to the home position connector guide track; and lockable to the home position connector guide track by turning the clamping element about a locking axis parallel to the insertion direction. Such an arrangement provides for a particularly simple and convenient attachment and repositioning of the home position connector.

According to embodiments, said first door guide may be defined by a top guide configured to guide respective top edge portions of said first and second doors. This locates much functionality to a position where it is not very visible, and does not increase the size of, or otherwise make it more difficult to pass, e.g. by a person, an object on wheels etc, the bottom rail.

According to embodiments, bottom edge portions of said first and second doors may comprise respective support arrangements, for example wheels, configured to carry the weight of said first and second doors when moving along said first guide. The wheels may be configured to roll in a bottom guide, or directly on a floor of a room in which the guided sliding door assembly is installed. The guide assembly may be installed on or adjacent to a ceiling to define a floor-to-ceiling guided sliding door assembly.

According to embodiments, the first door may comprise a door leaf; a guide shuttle guided in a shuttle guide track of said first door guide; and a shuttle connector configured to connect the door leaf to the guide shuttle, wherein the shuttle connector is connectable to the guide shuttle when the guide shuttle is positioned in the guide track. This makes the guided sliding door assembly easy to assemble. According to embodiments, the first door may comprise a door leaf; a guide shuttle guided in a shuttle guide track of said first door guide; and a shuttle connector configured to connect the door leaf to the guide shuttle, wherein the shuttle connector is configured to be snap-fit to the guide shuttle. Thereby, the door leaf of the first door may be conveniently connected to the respective guide shuttle with said first door guide mounted in its final position. Said shuttle connector may connect to the respective guide shuttle in a connection direction transversal to the guide axis, such as in a substantially vertical connection direction. Alternatively or additionally, also the second door may comprise a respective door leaf; a respective guide shuttle guided in a shuttle guide track of said first door guide; and a respective shuttle connector configured to connect the door leaf to the guide shuttle, wherein the shuttle connector is configured to be snap-fit to the respective guide shuttle. According to embodiments, each door may comprise a respective first-end guide shuttle and a respective second-end guide shuttle, along with respective guide shuttle connectors configured to snap-fit thereto.

According to embodiments, the first door may comprise a door leaf; a guide shuttle guided in a shuttle guide track of said first door guide; and a shuttle connector configured to connect the door leaf to the guide shuttle, wherein the door leaf comprises a shuttle connector guide guiding the shuttle connector along a vertical guide axis. Such an arrangement allows easy installation and adjustment of the door. Typically, the connector guide may be configured to guide the shuttle connector over a vertical guide range of more than 20 mm, for example more than 40 mm. Typically, the guide range may be less than 150 mm. Such ranges may accommodate for most variations of the installation conditions.

According to embodiments, the door guide assembly may further be configured to define a second door guide extending along a horizontal guide axis parallel to the first door guide, wherein the guided sliding door assembly further comprises a second door arrangement assembly comprising a respective first door assembly configured to define a first door guided by said second door guide, such that the first and second door arrangement assemblies together define a bypass door assembly. Also the second door guide may be defined by a respective guide track, which may be provided in a guide rail. The guided sliding door assembly may also comprise a third door guide guiding a third door arrangement comprising one or several respective doors in accordance with what is described herein with reference to the first and second door arrangement assemblies. The door(s) of the second door arrangement assembly may be movable independently of the doors of the first door arrangement assembly along the entire length of the second door guide. The first, second, and any third or additional door guides, along with any home position guide, may be defined by a single guide rail.

According to embodiments, the second door arrangement may further comprise a respective second door assembly configured to define a second door guided by said second door guide, wherein the second door guide is configured in accordance with the first door guide, mutatis mutandis, and the first and second door assemblies of the second door arrangement assembly are configured in accordance with the first and second door assemblies of the first door arrangement assembly, mutatis mutandis, as defined in any of the aspects and embodiments described hereinabove.

According to embodiments, the home position connector may be configured to be attached between said first and second door guides. Thereby, the home position connector may be arranged such that it can engage with a door guided by either of the first and second door guides, or both. According to embodiments, the home position connector may comprise a door connector interface for connecting to the respective door, wherein the home position connector can be attached between the first and second door guides with its door connector interface facing towards either of the first and second door guides.

According to a second aspect, there is provided a guided sliding door assembly comprising a door guide assembly configured to define a first door guide extending along a horizontal guide axis from a first guide end to a second guide end; and a first door arrangement assembly comprising a respective first door assembly configured to define a first door guided by said first door guide to be guidedly movable along the guide axis, the first door extending in a vertical door plane along the guide axis; wherein the door guide assembly comprises a home position connector configured to define a door home position at an intermediate position between the first and second guide ends, the home position connector being configured to automatically and releasably connect to said first door when reaching said door home position. The intermediate position may be at a distance from any door couplers defining end stops at the guide ends. The home position connector may be configured in accordance with the home position connectors of any of the embodiments defined hereinabove. Similarly, the door guide assembly, the first door arrangement assembly, and/or the entire guided sliding door assembly may be configured in accordance with the door guide assembly, the first door arrangement assembly and/or the guided sliding door assembly of any of the aspects and embodiments defined hereinabove.

According to a third aspect, there is provided a guided sliding door assembly comprising a door guide assembly configured to define a first door guide extending along a horizontal guide axis; and a first door arrangement assembly comprising a respective first door assembly configured to define a first door guided by said first door guide to be guidedly movable along the guide axis, the first door extending in a vertical door plane along the guide axis; wherein said first door guide is defined by a top guide configured to guide a top edge portion of said first door, and wherein said first door comprises a door leaf; a guide shuttle guided in a shuttle guide track of said first door guide; and a shuttle connector configured to connect the door leaf to the guide shuttle, wherein the door leaf comprises a shuttle connector guide guiding the shuttle connector along a vertical guide axis, and wherein the shuttle connector is configured to be snap-fit to the guide shuttle. Again, the door guide assembly, the first door arrangement assembly, and/or the entire guided sliding door assembly may be configured in accordance with the door guide assembly, the first door arrangement assembly and/or the guided sliding door assembly of any of the aspects and embodiments defined hereinabove.

According to a variant of the fourth aspect, there is provided a guided sliding door assembly comprising a door guide assembly configured to define a first door guide extending along a horizontal guide axis; and a first door arrangement assembly comprising a respective first door assembly configured to define a first door guided by said first door guide to be guidedly movable along the guide axis, the first door extending in a vertical door plane along the guide axis, wherein said first door comprises a door leaf; a guide shuttle configured to be guided in a shuttle guide track of said first door guide; and a shuttle connector movable in a vertical direction to connect the door leaf to the guide shuttle when the guide shuttle is positioned in the guide track. Such an arrangement facilitates installation of the guided sliding door assembly. The shuttle connector may be vertically movably arranged on the door leaf, to connect with the guide shuttle. Alternatively, the shuttle connector may be vertically movably arranged on the guide shuttle, to connect with the door leaf. Preferably, the shuttle connector is configured to enable tool-less connection to one of the door leaf and the guide shuttle.

According to embodiments, the door leaf may comprise a shuttle connector guide guiding the shuttle connector along a vertical guide axis. The vertical guiding of the shuttle connector may enable bridging a range of different gaps between the door leaf and the guide shuttle, which gap may vary depending on the local installation conditions. According to embodiments, the shuttle connector guide may be configured to guide the shuttle connector in a strictly translational motion. The vertical distance travelled by the shuttle connector in the translational motion may, for example, be between 10 mm and 70 mm. As an exemplary alternative to a vertically guided shuttle connector, the shuttle connector may be pivotally mounted on e.g. the door leaf, and pivot vertically into engagement with the shuttle connector.

According to embodiments, said first door guide may be defined by a top guide configured to guide a top edge portion of said first door.

According to embodiments, the shuttle connector may be configured to be snap-fit to the guide shuttle.

According to embodiments, the shuttle connector may be configured to enable, when connecting the door leaf to the guide shuttle, a vertical play between the door leaf and the guide shuttle. According to embodiments, the vertical play may exceed 3 mm. Such a range may be suitable for facilitating moderate adjustments of the vertical position of the door leaf in relation to the shuttle guide track, and/or may enable bridging a range of different gaps between the door leaf and the guide shuttle. According to further embodiments, said vertical play may exceed 5 mm or even 7 mm. Optionally, the vertical play may have an upper limit. For example, the vertical play may be less than 60 mm. A play of less than 60 mm may provide improved stability of the door leaf in a horizontal direction perpendicular to the door plane. According to further embodiments, said vertical play may be less than 40 mm. The vertical play may be obtained e.g. by arranging the shuttle connector at one of the door leaf and the guide shuttle in a shuttle connector guide, thereby enabling a guided vertical translation of the shuttle connector. The shuttle connector may remain guided over the entire vertical range defined by the vertical play.

According to embodiments, the shuttle connector may be configured to form an axially, with regard to the horizontal guide axis, rigid connection between the door leaf and the guide shuttle. For example, any axial flexibility of any snap-fit between the shuttle connector and the guide shuttle, as the case may be, may be supplemented by an additional, axially rigid, support interface between the shuttle connector and the guide shuttle.

According to embodiments, said shuttle guide track may comprise a guide track opening facing in a vertical direction, wherein the shuttle connector is connectable to the guide shuttle via the guide track opening.

According to embodiments, said guide shuttle may be configured as a coupler forming part of a soft closing mechanism configured to gradually brake a motion of the door leaf. For example, the guide shuttle may comprise one of a self-retractor and a self-retractor activator, which may be configured to couple to the other of a self-retractor and a self-retractor activator. The self-retractor may comprise a retraction bias element, such as a spring, configured draw the self-retractor towards the self-retractor activator. According to embodiments, the soft closing mechanism may be configured to gradually brake the motion of the door by means of a damper.

According to a fourth aspect, there is provided a method of connecting a door leaf of a sliding door to a door guide assembly comprising a top guide and a bottom guide, the door leaf comprising a bottom edge portion provided with a set of support arrangements, for example wheels, and a top edge portion provided with guide shuttle connectors configured to be connected to guide shuttles guided by the top guide, the method comprising: positioning the support arrangements in the bottom guide; aligning the guide shuttle connectors with the top guide; and vertically sliding the guide shuttle connectors upwards to snap into engagement with the guide shuttles. The method may be combined with any of the devices and assemblies defined hereinabove in accordance with the first to third aspects. For example, at least one of the guide shuttles may comprise a self-retractor of a soft closing mechanism.

It is noted that embodiments of the invention may be embodied by all possible combinations of features recited in the claims. Further, it will be appreciated that all embodiments of the guided sliding door assemblies according to the first aspect are combinable with the embodiments of the guided sliding door assemblies according to the second and third aspects. Moreover, the various embodiments described hereinabove for the devices of the first, second and third aspects are all combinable with the method as defined in accordance with the fourth aspect, and vice versa.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a view in perspective of a guided sliding door assembly comprising a guide assembly guiding two pairs of doors arranged in a bypass configuration;

FIG. 2 is a partly exploded view in perspective of a top portion of the guided sliding door assembly of FIG. 1, illustrating a top guide rail of the guide assembly drawn apart from the doors to expose guide shuttles guiding the doors in the top guide rail;

FIG. 3 is a perspective view of adjacent top corners of a first door and a second door of a first pair of the doors of FIG. 1, the first and second doors being separated along the top guide rail, wherein the top guide rail is illustrated partly in section to expose the respective guide shuttles of the respective doors, which guide shuttles are configured as door couplers configured to couple to one another, wherein the door coupler of the second door is configured as a self-retractor and the door coupler of the first door is configured as a self-retractor activator;

FIG. 4A is an exploded view of the self-retractor of FIG. 3 as seen from a first perspective;

FIG. 4B is an exploded view of the self-retractor of FIG. 4A as seen from a second perspective;

FIG. 5A is a section of the top guide rail and the door couplers of FIG. 3 as seen from below, the section taken along a horizontal plane indicated by the line V-V of FIG. 3, wherein the view illustrates the door couplers of FIG. 3 in a first mutual state along a guide axis defined by the top guide rail, the first mutual state corresponding to the doors independently moving towards each other along the guide axis;

FIG. 5B illustrates, in a view corresponding to that of FIG. 5A, the door couplers of FIG. 5A in a second mutual state along the guide axis, the second mutual state corresponding to the door couplers having reached each other along the guide axis and started to couple to each other;

FIG. 5C illustrates, in a view corresponding to that of FIG. 5A, the door couplers of FIG. 5A in a third mutual state along the guide axis, the third mutual state being a partly coupled state in which the self-retractor coupler draws itself towards the self-retractor activator;

FIG. 5D illustrates, in a view corresponding to that of FIG. 5A, the door couplers of FIG. 5A in a fourth mutual state along the guide axis, the fourth mutual state being a fully coupled state in which the first and second doors have come to rest in an abutment against each other, and the door couplers are statically biased towards each other;

FIG. 5E illustrates, in a view corresponding to that of FIG. 5A, the door couplers of FIG. 5A in a fifth mutual state along the guide axis, the fifth mutual state being a partly decoupled state in which the first and second doors are manually moved apart from each other such that the self-retractor is drawn away from the self-retractor activator against the attraction bias between the door couplers;

FIG. 5F illustrates, in a view corresponding to that of FIG. 5A, the door couplers of FIG. 5A in a sixth mutual state along the guide axis, the sixth mutual state corresponding to the first and second doors having been separated to a point where the self-retractor releases from self-retractor activator;

FIG. 6 illustrates a section of the top guide rail, a pair of side cover trim strips attached to the top guide rail and a support beam carrying the top guide rail, the section taken along the line VI-VI indicated in FIG. 2;

FIG. 7 is a partly exploded view in perspective of a first guide end of the top guide rail;

FIG. 8 is a perspective view of a bottom corner of the first door of FIG. 3 guided in a bottom guide rail of the guide assembly of FIG. 1, the bottom guide rail being illustrated in section;

FIG. 9 is a partly exploded view in perspective of the first door of FIG. 3, illustrating a door leaf, a guide shuttle of self-retractor type, a guide shuttle of self-retractor activator type, and two shuttle connectors for connecting the door leaf to the guide shuttles;

FIG. 10A is a perspective view of an interface region between the door leaf and the self-retractor activator guide shuttle of FIG. 9, the self-retractor activator guide shuttle being positioned inside the top guide rail of FIG. 6, immediately prior to connecting the respective shuttle connector to the self-retractor guide shuttle inside the top guide rail;

FIG. 10B is a perspective view of the interface region of FIG. 10A after having connected the shuttle connector to the self-retractor guide shuttle inside the top guide rail;

FIG. 11A is a perspective view of a section of the top guide rail of FIG. 2 along with an exploded view of a home position connector comprising a clamping element, illustrating the home position connector in a position disconnected from the top guide rail;

FIG. 11B corresponds to the view of FIG. 11A, and illustrates the home position connector clamped to the top guide rail;

FIG. 12A corresponds to the view of FIG. 11B, wherein all components but the clamping element are illustrated with dashed lines, and all components of the home position connector but the clamping element are transparent, the view illustrating the home position connector positioned at the intended attachment position of FIG. 11B, wherein the clamping element is illustrated prior to twisting to a lock position inside the top guide rail;

FIG. 12B corresponds to the view of FIG. 12a, the view illustrating the clamping element after having been twisted to a lock position inside the top guide rail;

FIG. 13 is a perspective view of the guide assembly of FIG. 1 guiding the first door of FIG. 3 in a movement direction towards a home position, wherein a magnified view illustrates a portion of the top guide rail with the home position connector of FIG. 11B attached thereto, along with a guide shuttle connector according to a second embodiment, the shuttle connector moving along the top guide rail from a position at which it is not connected to the home position connector to a position in which it engages with the home position connector; and

FIG. 14 is a perspective view of the guided sliding door assembly of FIG. 1 during the connection of the side cover trim strips of FIG. 6 to the top guide rail, along with two magnified views illustrating a first guide end of the top guide rail prior to and after connection of the side trim strips to the top guide rail.

All the figures are schematic, not necessarily to scale, and generally only show parts which are necessary in order to elucidate the embodiments, whereas other parts may be omitted.

### DETAILED DESCRIPTION OF THE EXEMPLARY EMBODIMENTS

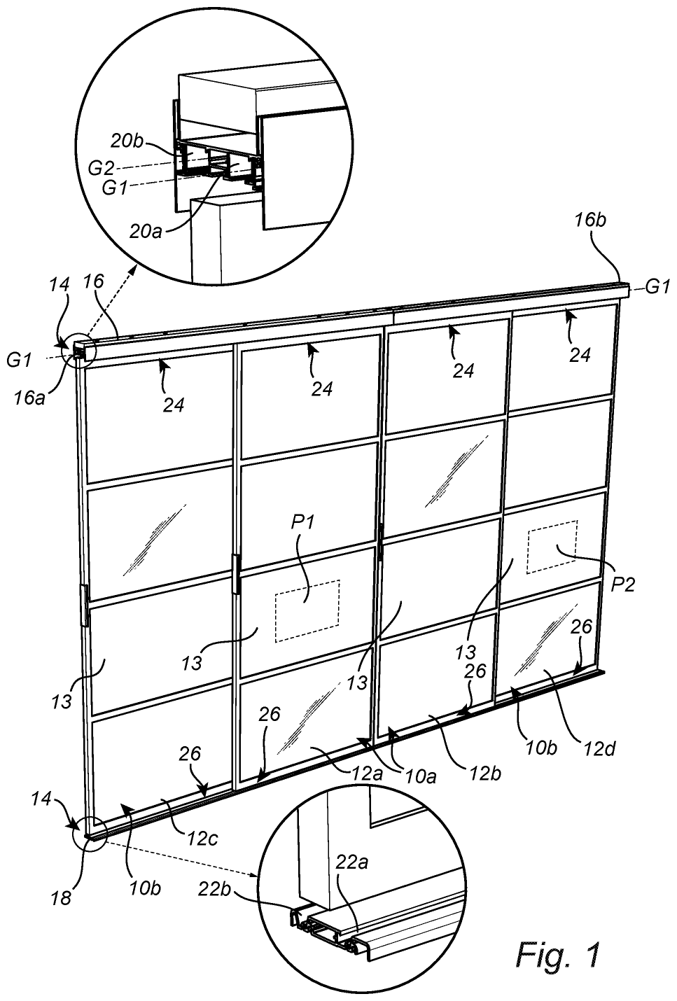

FIG. 1 illustrates a guided sliding door assembly 10 comprising a plurality of doors 12a-d guided by a guide assembly 14. The guide assembly 14 comprises a top guide rail 16 attached to a ceiling (not illustrated) of a room (not illustrated), and a bottom guide rail 18 attached to a floor (not illustrated) of the room; thereby, the guided sliding door assembly 10 is a floor-to-ceiling guided sliding door assembly. The plurality of doors comprises a first door arrangement 10a comprising a first door 12a and a second door 12b, and a second door arrangement 10b comprising a third door 12c and a fourth door 12d. The top guide rail 16 extends from a first guide end 16a to a second guide end 16b, and comprises a first top guide track 20a and a second top guide track 20b. The first top guide track 20a defines a first guide axis G1 extending in a horizontal direction, and the second top guide track 20b defines a second guide axis G2, which extends parallel to the first guide axis G1. Similar to the top guide rail 16, the bottom guide rail 18 comprises a first bottom guide track 22a and a second bottom guide track 22b.

Each of the first and second doors 12a-b comprises a respective door leaf 13 extending along a first vertical plane P1, and each of the third and fourth doors 12c-d comprises a respective door leaf 13 extending along a second vertical plane P2. Each of the first and second doors 12a, 12b has a respective top edge portion 24 which is guided by the first top guide track 20a of the top guide rail 16, and a respective bottom edge portion 26 which is guided by the first bottom guide track 22a of the bottom guide rail 18, to enable the first and second doors 12a, 12b to guidedly move along the first guide axis G1. Similarly, each of the third and fourth doors 12c, 12d has a respective top edge portion 24 which is guided by the second top guide track 20b of the top guide rail 16, and a respective bottom edge portion 26 guided by the second bottom guide track 22b of the bottom guide rail 18, to enable the second and third doors 12c, 12d to guidedly move along the second guide axis G2. Thereby, the first door arrangement 10a is guided independently of the second door arrangement 10b, such that the door arrangements 10a, 10b may freely pass each other along their respective guide axes G1, G2. As such, the guided sliding door assembly 10 defines a bypass door assembly. The guided sliding door assembly 10 of FIG. 1 is illustrated in assembled form, though it will be appreciated that a guided sliding door assembly as claimed herein may equally well be defined by a kit of components configured to be assembled to a guided door arrangement as described herein. Even though the guided sliding door assembly 10 of the illustrated embodiment comprises four doors 12a-d, the guided sliding door assembly 10 may comprise a different, i.e. greater or smaller, number of doors.

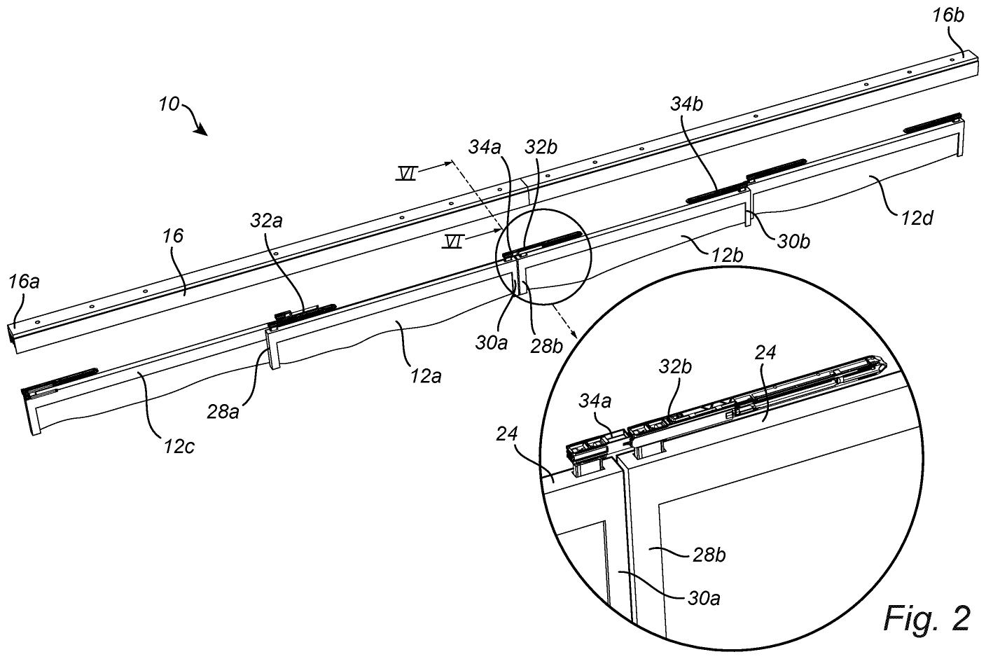

FIG. 2 illustrates a top portion of the guided sliding door assembly 10, with the doors 12a-d illustrated separated from the top guide rail 16. The first door 12a has a respective first door end 28a facing towards the first guide end 16a and a respective second door end 30a facing towards the second guide end 16b. At its first end 28a, the first door 12a has a respective first-end coupler 32a, which interfaces in a direction towards the first guide end 16a of the top guide rail 16. The first-end coupler 32a of the first door 12a is an end-stop coupler configured to, in a manner which will be elucidated further below, couple to a guide-end door coupler (not illustrated) at the first guide end 16a.

At its second end 30a, the first door 12a has a respective second-end coupler 34a which interfaces in a direction towards the second guide end 16b of the top guide rail 16. The second-end coupler 34a of the first door 12a is a door coupler configured to, in a manner which will be elucidated further below, couple to a mating coupler of the second door 12b. The first- and second-end couplers 32a, 34a of the first door 12a are attached to the top of the door leaf 13 of the first door 12a.

Similarly, the second door 12b has a first door end 28b facing towards the first guide end 16a and a second door end 30b facing towards the second guide end 16b. At its first end 28b, the second door 12b has a respective first-end coupler 32b which interfaces in a direction towards the first guide end 16a of the top guide rail 16. The first-end coupler 32b of the second door 12b is a door coupler configured to releasably couple to the second-end door coupler 34a of the first door 12b. In the view of FIG. 2, the first-end door coupler 32b of the second door 12b and the second-end door coupler 34a of the first door 12a are illustrated in a coupled position. At its second end 30b, the second door 12a has a respective second-end coupler 34b which interfaces in a direction towards the second guide end 16b of the top guide rail 16. In the illustrated embodiment, the second-end coupler 34b of the second door 12b is an end-stop coupler configured to couple to a guide-end door coupler (not illustrated) at the second guide end 16b. In an alternative embodiment (not illustrated), the second-end coupler 34b may instead be a door coupler configured to couple to yet another door guided in the first guide track 20a on the second-end side of the second door 12b. The first- and second-end couplers 32b, 34b are attached to the top of the door leaf 13 of the second door 12b.

The first- and second-end couplers 32a, 32b, 34a, 34b of the first and second doors 12a, 12b are also configured to be guided in the first top guide track 20a (FIG. 1) to be movable only in a direction along the first guide axis G1 (FIG. 1) of the top guide rail 16. Hereinbelow, the first- and second-end couplers 32a, 32b, 34a, 34b are therefore also, due to their double function and depending on the context, referred to as first- and second-end guide shuttles 32a, 32b, 34a, 34b. It will be appreciated, however, that the guiding function and the coupling function could alternatively be separated into different devices.

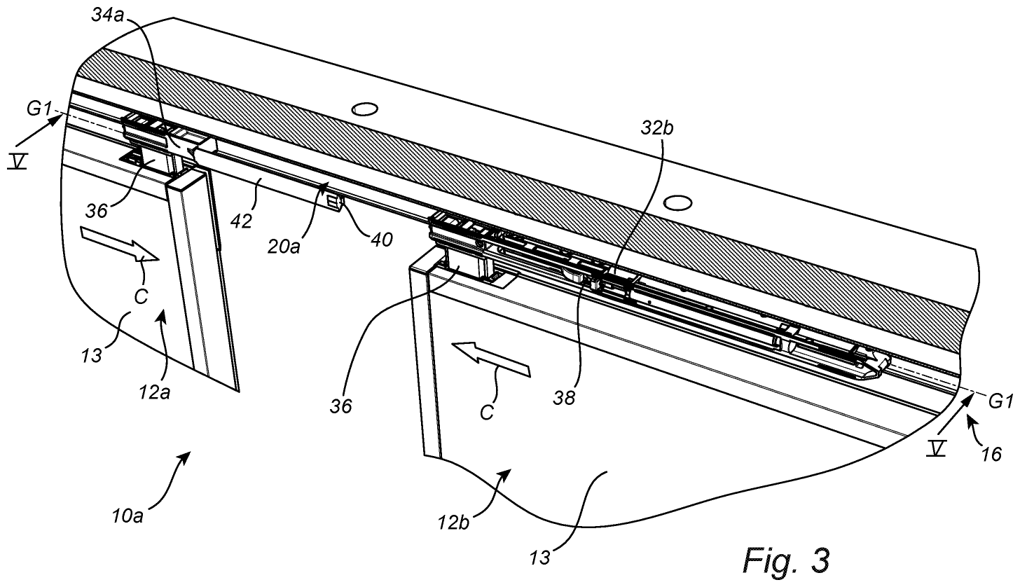

FIG. 3 illustrates a top portion of the first door arrangement 10a, with the top guide rail 16 in section to expose the second-end door coupler 34a of the first door 12a and the first-end door coupler 32b of the second door 12b inside the first top guide track 20a of the top guide rail 16. The door couplers/guide shuttles 34a, 32b are connected to the respective door leaves 13 via respective guide shuttle connectors 36.

The first-end door coupler 32b of the second door 12b defines a coupler interface of a first type, and the second-end door coupler 34a of the first door 12a defines a coupler interface of a second type, wherein the couplers 32b, 34a together define a soft-closing mechanism configured to gradually brake a relative motion between the first and second doors 12a, 12b along the first guide axis G1 when they move towards each other in a collision direction illustrated by arrows C. The coupler interface of the first type comprises a self-retractor 38, and the coupler interface of the second type comprises a self-retractor activator 40, wherein the self-retractor 38 is configured to, once having engaged with the self-retractor activator 40, draw itself towards second-end door coupler 34a of the first door 12a. The self-retractor activator 40 is positioned at a distal end of a self-retractor activator tongue 42 of the second-end door coupler of the first door 12a. Referring back to FIG. 2, the first-end coupler 32a of the first door 12a defines a coupler interface of the first type facing towards the first guide end 16a, and the second-end coupler 34b of the second door 12b defines a coupler interface of the first type facing towards the second guide end 16b.

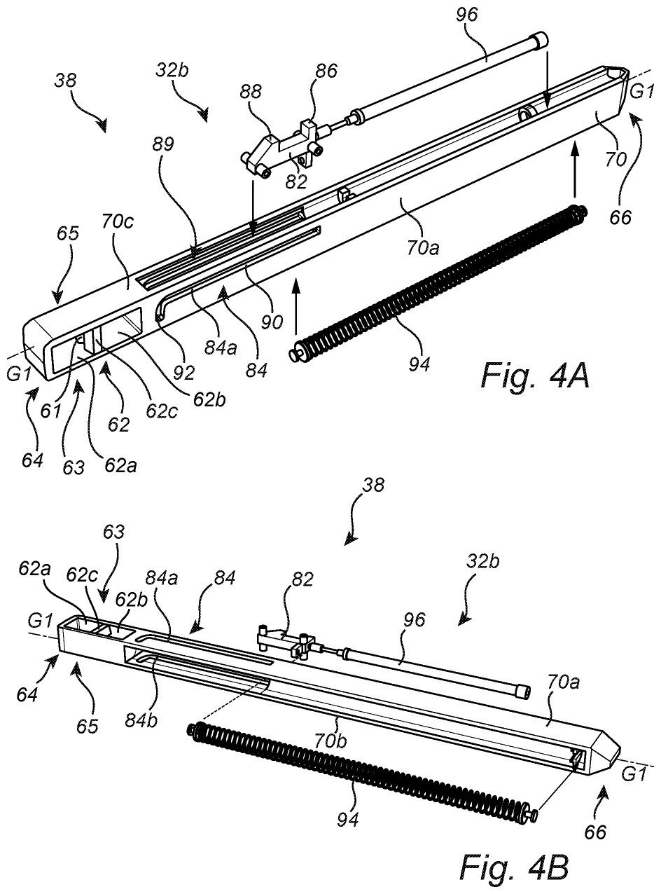

FIGS. 4A and 4B are exploded views of the self-retractor 38, exemplified by the first-end door coupler 32b of the second door 12b, as seen from two different perspectives. Again, it is pointed out that each of the first-end coupler 32a of the first door 12a and the second-end coupler 34b of the second door 12b may be identical to the first-end door coupler 32b of the second door 12b (FIG. 2).

The first-end door coupler 32b of the second door 12b comprises a housing 70 having a door leaf connector end 64 facing the towards the first guide end 16a (FIG. 1), and a damping arrangement end 66 facing the second guide end 16b (FIG. 1) of the top guide rail 16. The door leaf connector end 64 is provided with the door leaf connector 62. The door leaf connector 62 comprises a first socket aperture 62a and a second socket aperture 62b. The two socket apertures 62a, 62b are configured as through-holes extending from a bottom face 70a of the first-end door coupler 32b of the second door 12b to a top face 70b of the first-end door coupler 32b of the second door 12b. The two socket apertures 62a, 62b are separated by a divider post 62c. The door leaf connector 62 is functionally symmetric, allowing connecting a shuttle connector (to be described further below) thereto from any of two opposite faces 63, 65.

Within its housing 70, the first-end door coupler 32b of the second door 12b comprises a catcher carriage 82 provided with an activator catcher 86 and an activator retainer 88, each of which protrude from the housing 70 via an activator access track 89 extending axially along a side face 70c of the first-end door coupler 32b of the second door 12b. The catcher carriage 82 is movable along and guided by a carriage guide arrangement 84 comprising a pair of carriage guides 84a, 84b, which are formed alongside each other in the opposite bottom and top faces 70a, 70b of the housing 70 of the first-end door coupler 32b of the second door 12b. The carriage guide arrangement 84 comprises a straight portion 90, which extends parallel to the first guide axis G1, and a curved latch portion 92 adjacent to the door leaf connector 62. The catcher carriage 82 is shaped and guided such that when at the straight portion 90, both the activator catcher 86 and the activator retainer 88 protrude from the first-end door coupler 32b of the second door 12b via the activator access track 89 sufficiently to engage with the self-retractor activator 40 of the second-end door coupler 34a (FIG. 3) of the first door 12a. However, when in the latch portion 92, the catcher carriage 82 assumes a partly retracted position, in which only the activator catcher 86 protrudes from the first-end door coupler 32b of the second door 12b sufficiently to engage with the self-retractor activator 40 of the second-end door coupler 34a (FIG. 3) of the first door. The catcher carriage 82 is connected to the housing 70 of the first-end door coupler 32b of the second door 12b via a spring 94, which biases the catcher carriage 82 away from the partly retracted position adjacent to the door leaf connector 62, and via a damper 96, which damps the motion of the catcher carriage 82 along the carriage guide arrangement 84. Each of the spring 94 and the damper 96 has one end attached to the catcher carriage 82, and the other end firmly attached to the housing 70 of the first-end door coupler 32b of the second door 12b adjacent to the damping arrangement end 66 thereof.

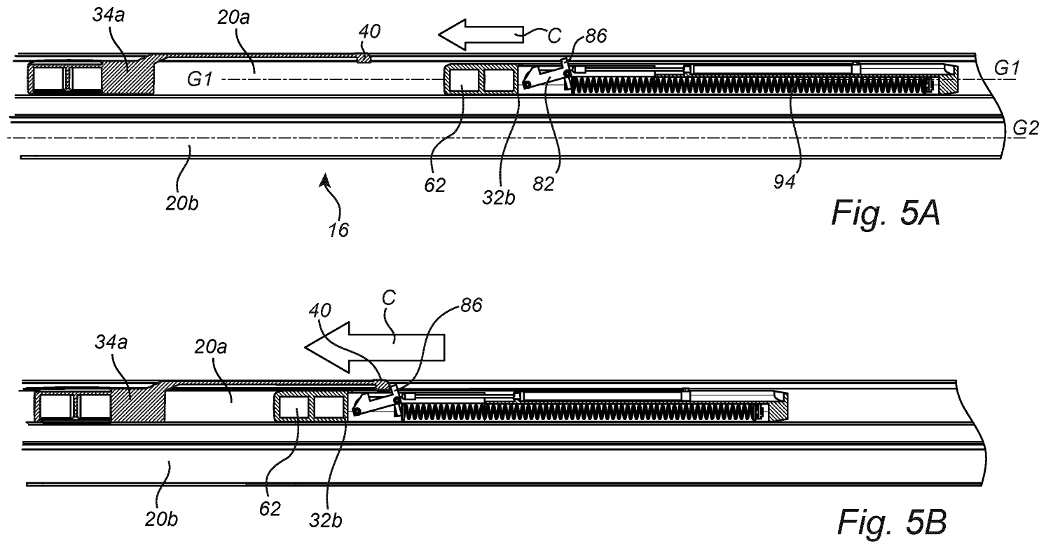

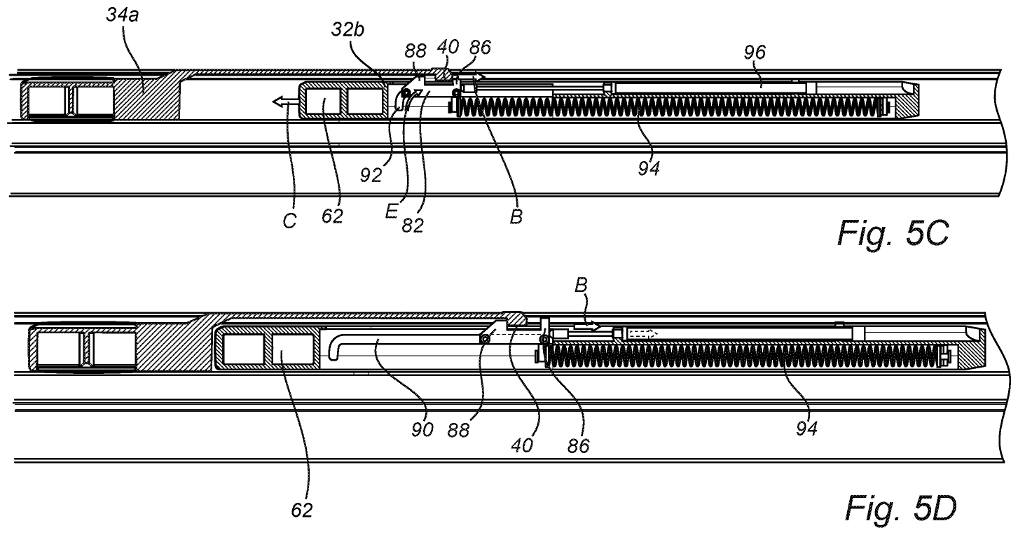

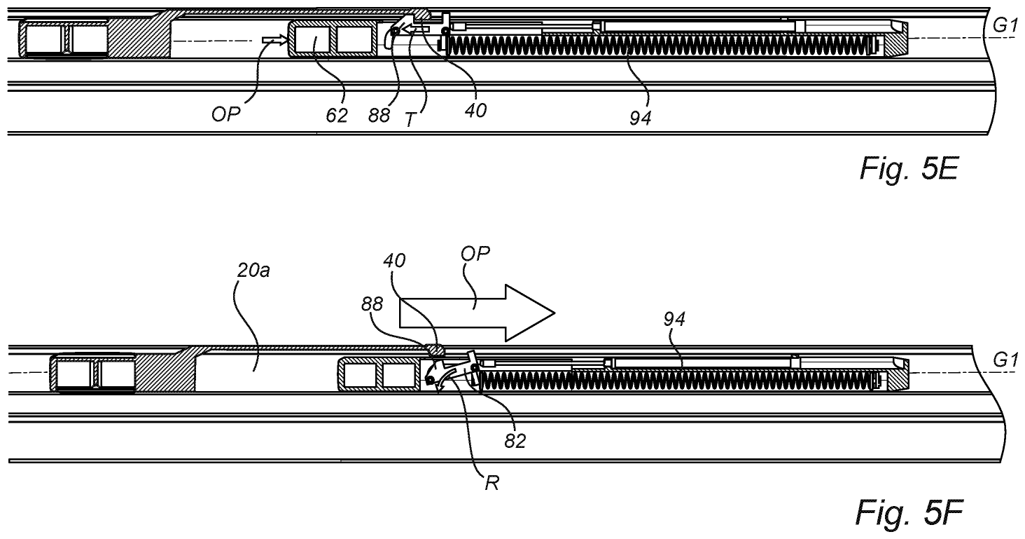

FIGS. 5A-5F illustrate the operation of the various components of the self-retractor 38 defining the first-end door coupler 32b of the second door 12b in relation to the second-end door coupler 34a of the first door 12a. It will be appreciated that the operation of the self-retractors defining the first- and second-end couplers 32a, 34b of the first and second doors 12a, 12b in relation to the respective guide-end door couplers of the top guide rail 16 may be identical.

Referring again to FIGS. 5A-5F, the operation is illustrated first in a scenario where the second door 12b (FIG. 1) collides with the first door 12a along a collision direction indicated by an arrow C (FIGS. 5A-5D), and then in a scenario where the first and second doors 12a-12b are drawn apart (FIGS. 5E-5F). For clarity of illustration, the relative motion between the first-end door coupler 32b of the second door 12b and the second-end door coupler 34a of the first door 12a is illustrated by assuming that only the second door 12b (FIG. 1) is moving; however, it will be appreciated that the interoperation between the first-end door coupler 32b of the second door 12b and the second-end door coupler 34a of the first door 12a will be identical if both doors 12a, 12b (FIG. 1) are moving, or if only the first door 12a is moving. The scenarios are illustrated in a section taken along a horizontal plane coinciding with the guide axis G1 indicated in FIG. 3, and as seen from below.

In the position of FIG. 5A, the second door 12b (FIG. 3) is manually moved in a collision direction C towards the first door 12a (FIG. 3), and runs along the first top guide track 20a independently of the first door 12a. In this position, the first-end door coupler 32b of the second door 12b is in an unconnected state, in which the catcher carriage 82 is trapped in a partly retracted position in the latch portion 92 (FIG. 4A) of the carriage guide arrangement 84 (FIG. 4A), such that the spring 94 is held in an extended/tensioned state by the trapped catcher carriage 82. In the view of FIG. 5A, the first-end door coupler 32b of the second door 12b approaches the second-end door coupler 34a of the first door 12a. Thereby, the catcher carriage 82 approaches the self-retractor activator 40 of the second-end door coupler 34a of the first door 12a. With the catcher carriage 82 in the partly retracted position, the activator catcher 86 protrudes out of the activator access track 89 (FIG. 4A) sufficiently to engage with the self-retractor activator 40, whereas the activator retainer 88 is sufficiently retracted to freely pass the self-retractor activator 40.

FIG. 5B illustrates the moment when the activator catcher 86 engages with the self-retractor activator 40.

Now with reference to FIG. 5C, as the collision motion C continues, the self-retractor activator 40 draws the catcher carriage 82 from the partly retracted position in the latch portion 92 of the carriage guide arrangement 84 (FIG. 4A), into the straight portion 90 (FIG. 4A) thereof. Thereby, the catcher carriage 82 pivots in an engage direction E, such that also the activator retainer 88 protrudes out of the activator access track 89 (FIG. 4A) sufficiently to engage with the self-retractor activator 40. In the position reached thereby, the self-retractor activator 40 is trapped between the activator catcher 86 and the activator retainer 88. The catcher carriage 82, now free to move along the straight portion 90 (FIG. 4A) of the carriage guide arrangement 84 (FIG. 4A), is drawn away from the door leaf connector 62 by the bias B of the spring 94, thereby drawing the door leaf connector 62 of the first-end door coupler 32b of the first door 12b (FIG. 2) in the collision direction C towards the second-end door coupler 34a of the first door (FIG. 2). The motion is damped by the damper 96.

FIG. 5D illustrates the situation once the first-end door coupler 32b of the second door 12b has reached its end position in relation to the second-end door coupler 34a of the first door 12a, corresponding to the position illustrated in FIG. 2. The second door 12b (FIG. 2) now rests against the first door 12a (FIG. 2), and remaining bias B in the spring 94 maintains a pressure between the activator retainer 88 and the self-retractor activator 40, thereby maintaining a contact pressure between the doors 12a, 12b in the collision direction C. The bias B in the spring defines a door disengagement limit force which needs to be overcome in order to draw the doors apart.

In FIG. 5E, the first and second doors 12a, 12b (FIG. 2) are manually drawn apart against the bias B (FIG. 5D) by moving the second door 12b in an opening direction OP along the first guide axis G1, while holding the first door 12a stationary. Still, the first-end door coupler 32b of the second door 12b follows the motion of the second door 12b via the engagement between the door leaf connector 62 and the respective shuttle connector 36. The engagement between the self-retractor activator and the activator retainer 88 moves the catcher carriage 82 in a spring tensioning direction T along the carriage guide arrangement 84 (FIG. 4A), towards the door leaf connector 62, thereby tensioning the spring 94.

Continuing to draw the second door 12b (FIG. 2) in the opening direction OP, and now with reference to FIG. 5F, the catcher carriage 82 will reach the latch portion 92 of the carriage guide arrangement 84 (FIG. 4A), and pivot in a retraction direction R. Once in the retracted position, the activator retainer 88 disengages from the self-retractor activator 40, such that the first-end door coupler 32b of the second door 12b (FIG. 2) is again free from the second-end door coupler 34a of the first door 12a (FIG. 2), allowing the first and second doors 12a, 12b to move independently of each other along the first guide axis G1. The bias of the spring 94 maintains the catcher carriage 82 locked in the partly retracted position until the next time the doors 12a, 12b collide together, which would again bring us back to the situation of FIG. 5A.

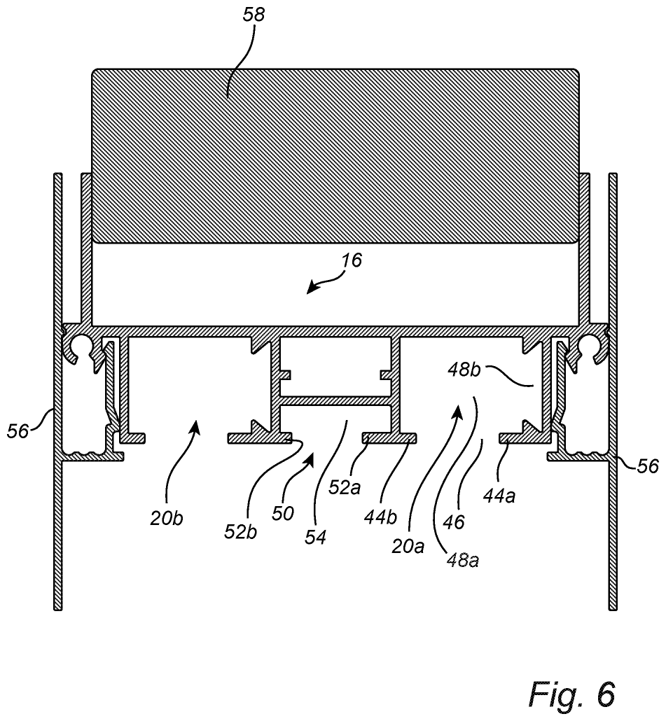

FIG. 6 illustrates the top guide rail 16 in a cross-section indicated by VI-VI in FIG. 2. The first and second top guide tracks 20a, 20b are integrally formed within the top guide rail 16, which is configured as an extruded profile of e.g. metal. The bottom of the first top guide track 20a is defined by a pair of support flanges 44a, 44b, which extend towards one another and provide a vertical support face for the couplers/guide shuttles 32a, 34a, 32b, 34b (FIG. 3). The pair of support flanges 44a, 44b defines between them a downwards-facing guide track opening which operates as a door connection track 46, through which the shuttle connectors 36 (FIG. 3) extend when connected to the respective couplers/guide shuttles 32a, 34a, 32b, 34b (FIG. 2). The first top guide track 20a comprises a shuttle guide track 48a, which guides the couplers/guide shuttles 32a, 32b, 34b that have a connector interface of the first type, along with a main body of the guide shuttle 34a having a connector interface of the second type. The first top guide track 20a also comprises coupler activator guide track 48b, which communicates with the shuttle guide track 48a, and guides the self-retractor activator tongue 42 (FIG. 3) of the second-end door coupler 34a of the first door 12a. The coupler activator guide track 48b is dovetailed to firmly guide the self-retractor activator 40. This increases the stability of the self-retractor activator 40 also in the direction along the first guide axis G1, which may be useful e.g. in case the self-retractor activator 40 is made of a relatively soft material, such as plastic.

The second top guide track 20b has a similar shape, with the very same function, for guiding the third and fourth doors 12c, 12d (FIG. 1) of the second door arrangement 10b (FIG. 1). For the purpose, the doors 12c, 12d of the second door arrangement 10b (FIG. 1) may be provided with guide shuttles which are configured in the same manner as the guide shuttles of the first door arrangement 10a (FIG. 1). The top guide rail 16 also defines a home position connector guide 50, the function of which will be elucidated further below. Similar to the first and second top guide tracks 20a, 20b, also the home position connector guide 50 is defined by a guide track 54. The home position connector guide track 54 has a bottom defined by a pair of support flanges 52a, 52b, which extend towards one another and define between them a downwards-facing home position connector insertion gap. Side cover trim strips 56 are snap-fit to the top guide rail 16, and the top guide rail is attached in a non-illustrated manner to a top guide rail support beam 58, which may extend across a ceiling (not illustrated).

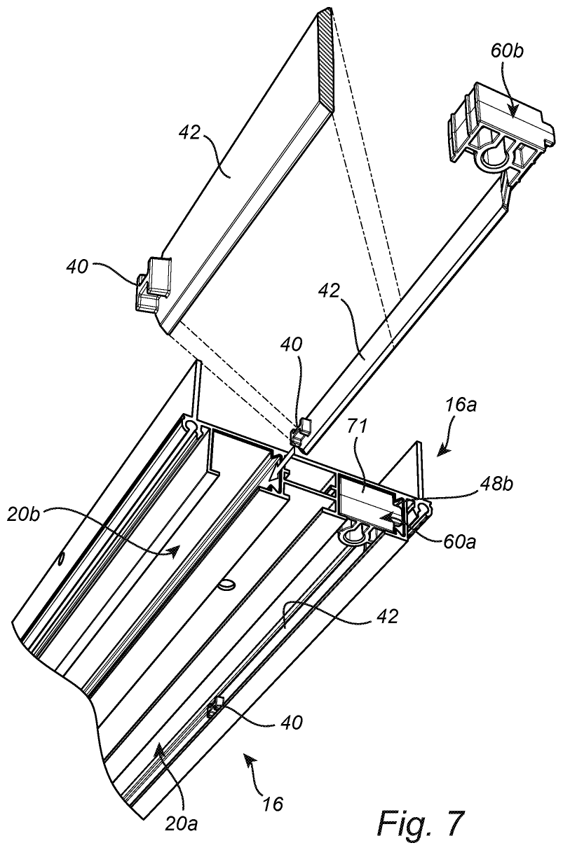

FIG. 7 illustrates the first guide end 16a of the top guide rail 16. The first top guide track 20a is, at the first guide end 16a, provided with a respective first guide-end door coupler 60a, which is fixedly attached within the first guide track 20a. The first guide-end door coupler 60a is configured to couple to the end-stop coupler 32a (FIG. 2) of the first door 12a (FIG. 2) and, together with the end-stop coupler 32a of the first door 12a, define a soft-closing mechanism configured to gradually brake and stop the motion of the first door 12a when reaching the first guide end 16a. For the purpose, the first guide-end door coupler 60a has a coupler interface of said second type, comprising a respective self-retractor activator 40 positioned at the end of a self-retractor activator tongue 42 inserted in the coupler activator guide track 48b. The first guide-end door coupler 60a, which may be integrally formed of e.g. plastic or metal, comprises and end cap 71 which is press-fit within and/or screwed to the first guide end 16a of the first guide track 20a, and the self-retractor activator tongue 42 extends from the end-cap 71 towards the second guide end 16b to hold the self-retractor activator 40 at a distance from the first guide end 16a. The first guide-end door coupler 60a couples to the end-stop coupler 32a (FIG. 2) of the first door 12a (FIG. 2) in the very same manner as that described in detail hereinbefore for how the second-end door coupler 34a (FIG. 2) of the first door 12a couples to the first-end door coupler 32b of the second door 12b. A similar first guide-end door coupler 60b, which is illustrated drawn out from the respective guide track 20b, is also positioned within the second guide track 20b to provide soft closing functionality at the first guide end 16a for the second door arrangement 10b (FIG. 1). Similar guide-end door couplers (not illustrated) are provided at the second guide end 16b (FIG. 2) of the top guide rail 16 for gradually braking the second door 12b (FIG. 2), as well as its sibling 12d in the second door arrangement 10b (FIG. 1), when reaching the second guide end 16b.

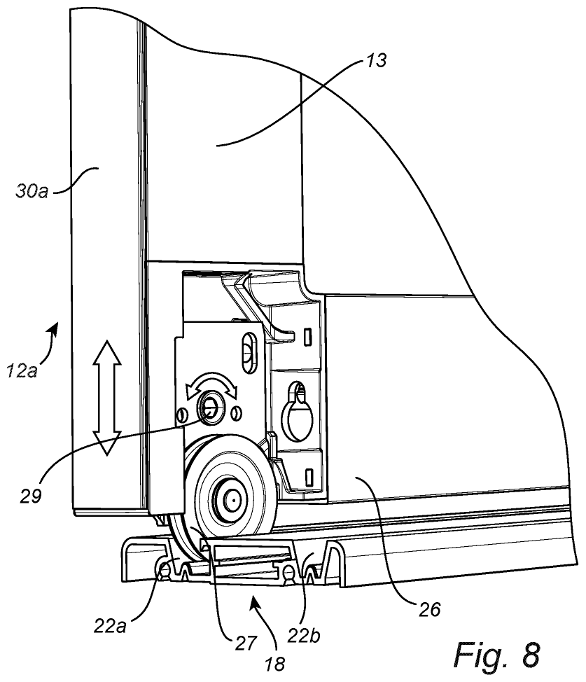

FIG. 8 illustrates a lower corner of the second end 30a of the first door 12a as seen from the rear side of the door. The bottom edge portion 26 of the first door 12a is provided with a wheel 27, which rests in, and is guided by, the first bottom guide track 22a of the bottom guide rail 18. The door leaf 13 is vertically adjustable in relation to the wheel 27 by turning an adjustment screw 29, which turns an eccentric (not illustrated) determining the vertical relationship between the door leaf 13 and the wheel 27. A similar adjustable wheel is arranged at the lower corner of the first end 28a of the first door 12a, as well as the lower corners of the second, third and fourth doors 12b, 12c, 12d.

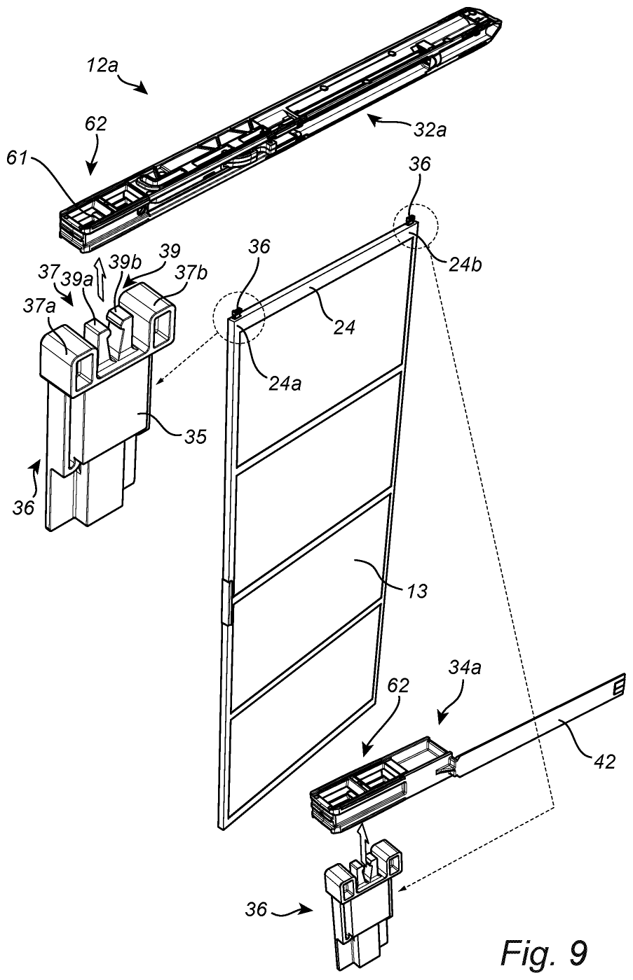

FIG. 9 illustrates in isolation the components connecting the door leaf 13 of the first door 12a to the respective first- and second-end guide shuttles/couplers 32a, 34a. A first-end top corner 24a of the door leaf 13 is provided with a shuttle connector 36 comprising a respective guide shaft 35 and a respective connector interface 37. The guide shaft 37 is configured to be guided in a shuttle connector guide (not illustrated) in the top portion of the door leaf 13 of the first door 12a, to enable a guided vertical translation of the shuttle connector 36 in relation to the door leaf 13. The shuttle connector 36 may thereby be connected upwards to bridge the vertical gap between the door leaf 13 and the respective guide shuttle 32a, 34a. An exemplary vertical translation range of the shuttle connector 36 may be, e.g., between 10 mm and 70 mm. The connector interface 37 comprises a first support tongue 37a configured to enter the first socket aperture 62a (FIG. 4A), a second support tongue 37b configured to enter the second socket aperture 62b (FIG. 4A), and a snap connector 39 comprising resilient snap tongues 39a, 39b configured to releasably engage with the divider post 62c (FIG. 4A). When the connector interface 37 is pressed upwards into the door leaf connector 62 of the first-end guide shuttle 32a, the snap tongues 39a, 39b are resiliently pressed apart by the divider post 72 in a horizontal direction along the first guide axis G1 (FIG. 4A), and spring back into engagement with a groove 61 in the divider post 62c. While the snap tongues 39a, 39b are flexible in the direction of the first guide axis G1, the support tongues 37a, 37b provide a supplementary axial support, along the first guide axis G1, between the door leaf connector 62 and the connector interface 37 of the shuttle connector 36.

The second-end guide shuttle 34a is provided with a door leaf connector 62 identical to the door leaf connector 62 of the first-end guide shuttle 32a, and a second-end top corner 24b of the door leaf 13 is provided with an identical vertically guided shuttle connector 36 for connection to the door leaf connector 62 of the second-end guide shuttle/door coupler 34a.

After having connected the door leaf 13 to the respective guide shuttle 32a, 34a, the shuttle connector 36 remains vertically movable in the shuttle connector guide, which enables a vertical play between the door leaf 13 and the respective guide shuttle 32a, 34a. The vertical play may take up a certain amount of variation of the distance between the top guide rail 16 and the bottom guide rail 18 while the door 12a moves along the guide rails 16, 18. The guided vertical play enabled by the guided connection may be, by way of example, between 3 mm and 60 mm.

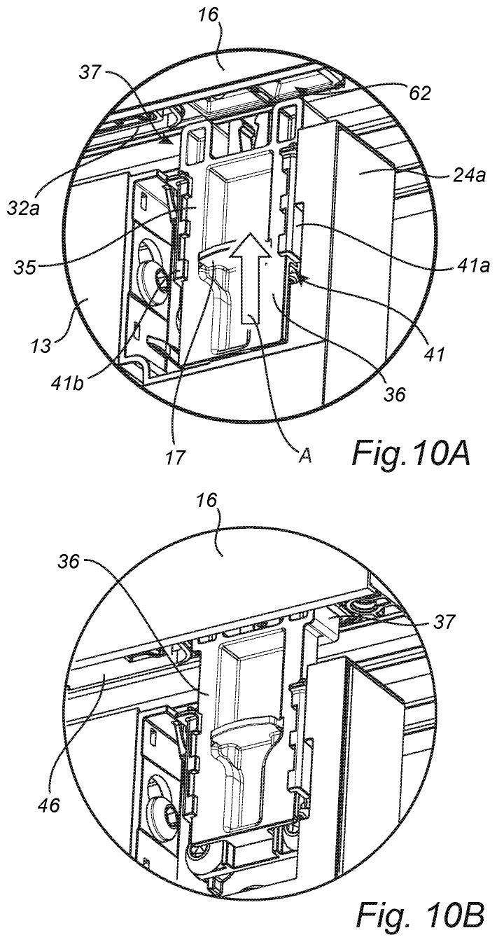

FIGS. 10A and 10B illustrate the connection of the door leaf 13 of the first door 12a to the respective first- and second-end guide shuttles/couplers 32a, 34a (FIG. 9), and in particular, the connection of the shuttle connector 36 of the first-end top corner 24a to the first-end guide shuttle. It will be appreciated that the shuttle connector 36 of the second-end top corner 24b (FIG. 9) is connected to the second-end guide shuttle 34a in the very same manner, and that also the top corners of the second door 12b (FIG. 2) connected to the respective guide shuttles 32b, 34b in the same manner. Clearly, the same may apply to the third and fourth doors 12c, 12d, mutatis mutandis. Prior to connecting the top edge portion of the door leaf 13 to the guide shuttles 32a, 34a, the wheels 27 (FIG. 8) of the bottom edge portion 26 of the door leaf are positioned in the first bottom guide track 22a (FIG. 8) of the bottom guide rail 18. The door leaf 13 is pivoted about a pivot axis defined by the engagement between the wheels 27 and the first guide track 22a to the position of FIG. 10A, in which the connector interface 37 of the shuttle connector 36 of the first-end top corner 24a of the first door 12a is in register with the door leaf connector 62 of the first guide shuttle 32a of the first door 12a.

After having reached the position illustrated in FIG. 10A, the shuttle connector 36 is pushed upwards via a push tab 17. In this motion, the guide piston 35 guided along a vertical guide axis, indicated by an arrow A, by a shuttle connector guide 41 defined by a pair opposing guide elements 41a, 41b. Once having reached the vertical position illustrated in FIG. 10B, the connector interface 37 will snap into engagement with the door leaf connector 62 (FIG. 10A) of the first guide shuttle 32a. The shuttle connector guide 41 guides the shuttle connector 36 over a vertical guide range of about 50 mm. Thereby, the vertically movable shuttle connector 36 enables taking up a quite substantial play between the top edge of the door leaf 13 and the top guide rail 16. The shuttle connector 36 may also remain vertically movable during the use of the sliding door, to compensate for any differences in the vertical distance between the top guide 16 and the bottom guide 18 along the guiding range of the first door 12a along the guide assembly 14 (FIG. 1).

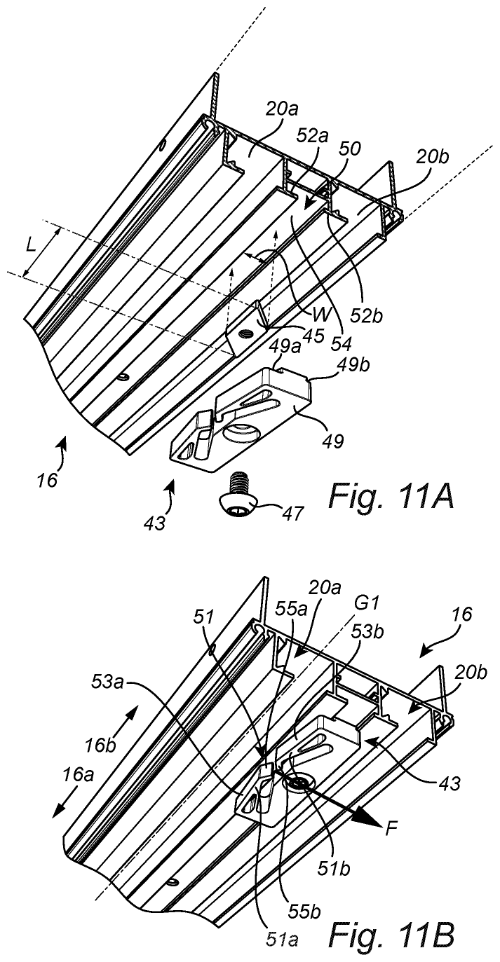

Now turning to FIGS. 11A and 11B, the guide assembly 14 comprises a home position connector 43, which is attachable to the top guide rail 16 at an arbitrary position along the length of the top guide rail 16. The home position connector 43 may be used for defining a home position for any of the doors 12a, 12b, 12c, 12d (FIG. 1) at an intermediate position between the first and second guide ends 16a, 16b such that, when reaching the home position connector, the respective door 12a, 12b, 12c, 12d automatically connects to and is stopped by the home position connector 43. The home position connector 43 is attachable to the home position connector guide track 50 by inserting a clamping element 45 of the home position connector 43 into the home position connector guide 50, and clamping the clamping element 45 against upper faces of the support flanges 52a, 52b by tightening a clamping screw 47. A pair of alignment shoulders 49a, 49b of a main body 49 of the home position connector 43 reach into the home position connector guide track 54 and bear against the support flanges 52a, 52b when tightening the clamping screw 47, thereby preventing the main body 49 of the home position connector 43 from rotating with the clamping screw 47. As illustrated in the view of FIG. 11A, the clamping element 45 has a length L along the direction of elongation of the home position guide track 54 which exceeds the free width W between the support flanges 52a, 52b such that the clamping element 45 is insertable into the home position connector guide track 54 when the clamping element's 45 direction of elongation extends parallel to the home position connector guide track 54, and is locked to the home position connector guide track when the clamping element 45 is turned, by turning the clamping screw, to a position where its direction of elongation is transversal to the home position connector guide track 54.

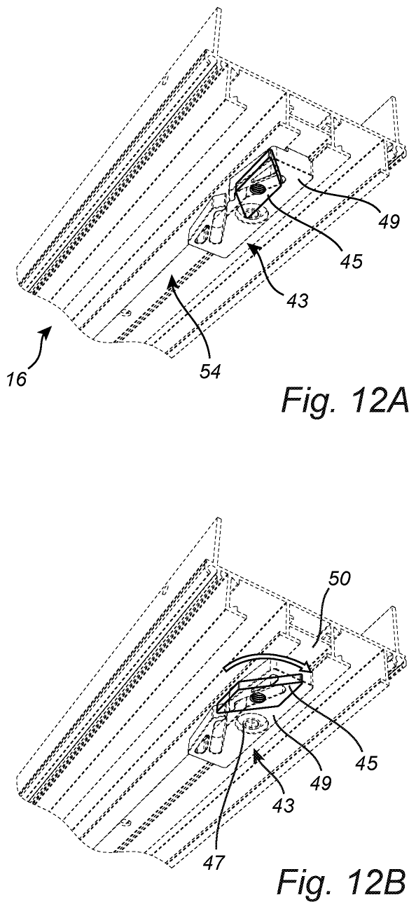

The attachment of the home position connector 43 is more clearly illustrated in the transparent views of FIGS. 12A and 12B. First, the home position connector is positioned below the top guide rail 16 such that the clamping element 45 extends into the home position connector guide 50, as illustrated in the view of FIG. 12A. Thereafter, and now moving to FIG. 12B, the clamping screw 47 is tightened clock-wise, twisting the clamping element 45 about a vertical axis to a position in which the clamping element is vertically locked inside the home position connector guide 50. When in the position of FIG. 12B, the clamping screw 47 may be further tightened until the support flanges 52a, 52b are firmly clamped between the clamping element and the main body 49 of the home position connector 43.

Referring back to FIG. 11B, the home position connector 43 has a door connector interface 51 facing towards the first guide track 20a of the top guide rail 16. As may however be apparent from FIGS. 11A and 11B, the home position connector 43 is however functionally symmetric in a first sense, in that it can alternatively be connected in a position (not illustrated) with the door connector interface 51 facing towards the second guide track 20b instead. The door connector interface 51 comprises a first spring arm 51a and a second spring arm 51b which are configured to resiliently flex, against an intrinsic bias of the spring arms 51a, 51b, in a flexing direction F away from the first guide track 20a, perpendicular to the first guide axis G1. As seen along the first guide axis G1, the first spring arm 51a has a relatively flatter connection flank 53a which, in the illustrated position, faces towards the first guide end 16a, and a relatively steeper locking flank 55a facing towards the second guide end 16b. Similarly, the second spring arm 51b has a relatively flatter connection flank 53b facing towards the second guide end 16b, and a relatively steeper locking flank 55b facing towards the first guide end 16a.

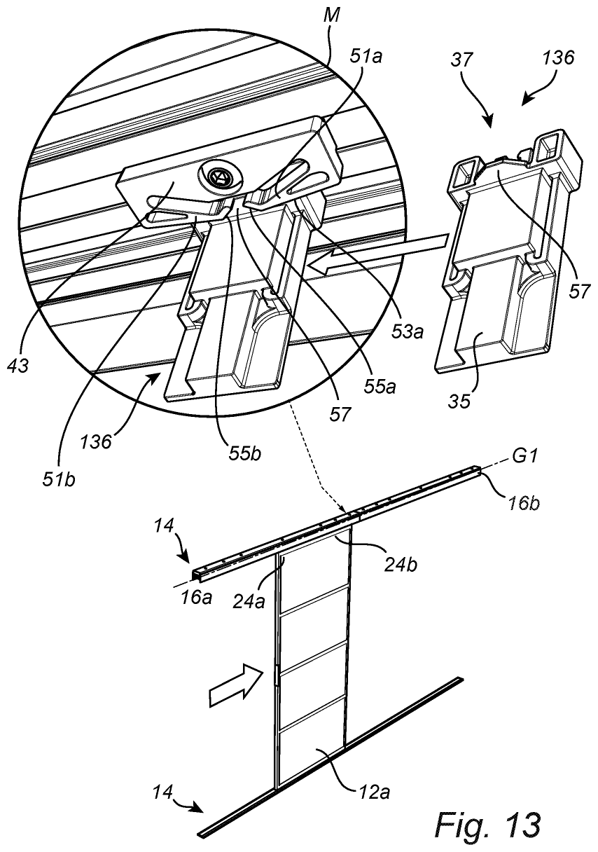

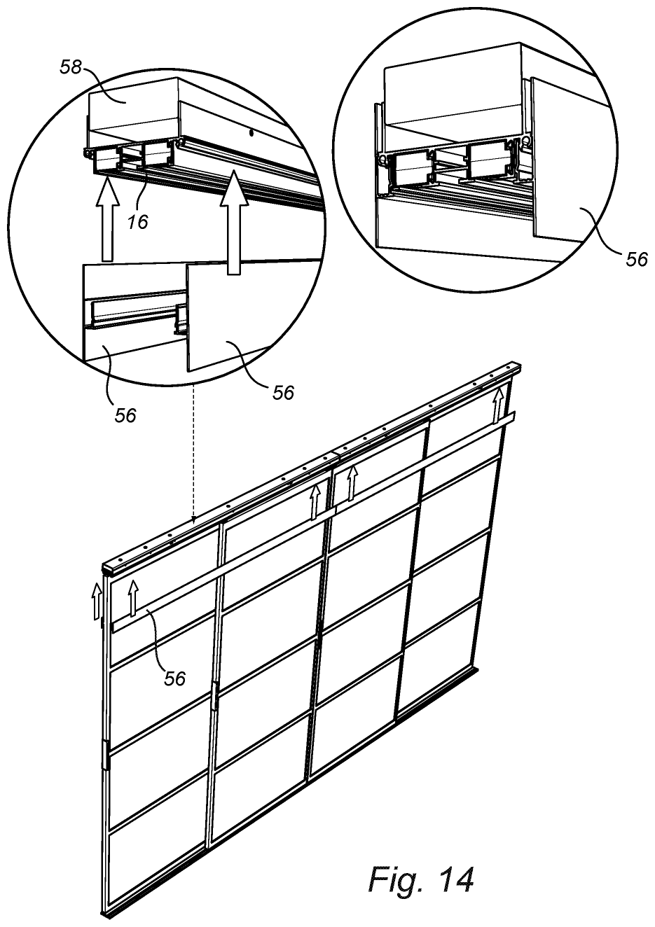

FIG. 13 illustrates the operation of the home position connector 43 when used for defining a home position of a door, such as the first door 12a. For the purpose, the first door is provided with one shuttle connector 136 according to an alternative, second embodiment. The shuttle connector 136 according to the second embodiment is identical to the shuttle connector 36 according to the first embodiment described in detail further above, with the difference that the shuttle guide 136 according to the second embodiment comprises a home position engagement element 57, which is configured to engage with the home position connector 43. In the illustrated example, the shuttle connector at the first-end top corner 24a is a shuttle connector 136 provided with a hone position engagement element 57 according to the second embodiment, whereas the second-end top corner of the door leaf 13 may be provided with a shuttle connector 36 in accordance with the first embodiment, which is not illustrated in detail again in the view of FIG. 13. For reasons of clarity, the magnified portion of the view of FIG. 13 is illustrated with the door leaf 13, the first-end guide shuttle 132a, and the shuttle connector guide 41 broken away to clearly expose the shuttle connector 136 and its interoperation with the home position connector 43.

In the scenario illustrated in FIG. 13, the first door 12a moves along the guide assembly 14 in a direction illustrated by an arrow, the shuttle connector 136 moving towards the axial position of the home position connector 43 along the first guide axis G1. When reaching the home position connector 43, the home position engagement element 57 of the shuttle connector 136 slides along the relatively flatter connection flank 53a of the first spring arm 51a, and thereby presses the first spring arm 51a in the flexing direction F (FIG. 11B). Once having reached the position between the spring arms 51a, 51b illustrated in the magnified view enclosed by a circle M, the first spring arm 51a is allowed to snap back again in a direction opposite to the flexing direction F illustrated by the arrow in FIG. 11B. At the same time, the home position engagement element 57 is stopped by the relatively steeper locking flank 55b of the second spring arm 51b, such that the home position engagement element 57 is trapped between the relatively steeper locking flanks 55a, 55b of the spring arms 51a, 51b. Clearly, this also stops the motion of the first door 12a, which has thereby found its home position. The first door 12a can be released from the home position by pushing the first door 12a in either direction along the first guide axis G1 with a force exceeding a home position release limit force, which limit force is determined inter alia by the steepness of the locking flanks 55a, 55b and the spring constants of the spring arms 51 am 51b. The home position release limit force may be adapted such that it exceeds the door disengagement force B described further above with reference to FIG. 5D.

As may be apparent from the design of the home position connector 43, the home position connector 43 is functionally symmetric also in a second sense, in that the home position connector 43 is configured to connect to the home position connector engagement element 57 regardless of from which direction along the first guide axis G1 the home position connector engagement element 57 reaches the home position connector 43. Similarly, when in the home position, the home position connector engagement element 57 can be released from the home position connector 43 by pushing the door 12a in either direction along the first guide axis G1. It is pointed out that even though the home position engagement element 57 of FIG. 13 is arranged on the shuttle connector 136, it could equally well be arranged on any other portion of the door 12a, in any position suitable for engaging with the home position connector 43. It may provide some benefits with regard to intuitiveness of operation if only one of the doors of each door arrangement 10a, 10b is provided with a home position engagement element, whereas other doors of the respective door arrangement 10a, 10b may find their respective home positions by coupling, directly or via other doors, to the door having a home position engagement element 57. However, a single door may be given several home positions by having multiple home position engagement elements, or by positioning multiple home position connectors 43 along the respective door guide. Similarly, more than one door of a door arrangement 10a, 10b may be provided with one or several home position engagement elements 57.

FIG. 14 illustrates the attachment of the side cover trim strips 56 to the top guide rail 16 to cover the top guide rail 16 as well as its attachment to the support beam 58. The side cover trim strips 56 are configured as extruded profiles permitting toolless attachment to the top guide rail 16 by pressing them vertically upwards, the extruded profiles of the side cover trim strips 56 thereby snapping to the extruded profile of the top guide rail 16.

In summary, the description hereinabove in detail describes, inter alia, a sliding door assembly 10 which comprises a door guide 20a extending along a horizontal guide axis G1, a first door 12a guided by the door guide 20a; and a second door 12b guided by the door guide 20a independently of the first door 12a, wherein the second door 12b comprises a first-end door coupler 32b which interfaces in a direction towards a first guide end 16a of the door guide 20a; and the first door 12a comprises a second-end door coupler 34a which interfaces in a direction towards a second guide end 16b of the door guide 20a to couple to the first-end door coupler 32b of the second door, wherein the first- and second-end door couplers 32b, 34a together define a soft-closing mechanism configured to gradually brake a relative motion between the first and second doors 12a, 12b.

The invention has mainly been described above with reference to a few embodiments. In particular, a soft-closing mechanism between a pair of doors arranged in line with each other in a common guide has been described in detail. However, as is readily appreciated by a person skilled in the art, other embodiments than the ones disclosed above are equally possible within the scope of the invention, as defined by the appended patent claims.

For example, in the embodiments described in detail hereinabove, the soft-closing mechanism is arranged in the guide shuttles of the top guide rail. This is not necessary. Alternatively, the guide shuttles may have no other function than that of guiding the top of the door, and the soft-closing mechanism may be implemented as separate components carried by the respective doors. A soft-closing mechanism carried within the top guide rail has been described in detail. Alternatively, the soft-closing mechanism between the in-line doors may be positioned e.g. within or adjacent to the bottom guide rail, or at any other suitable position where the doors meet. The doors have been described as guided by guide shuttles arranged within guide tracks. This is not necessary; many other types of guides exist.

In the claims, the word “comprising” does not exclude other elements or steps, and the indefinite article “a” or “an” does not exclude a plurality.

1. A guided sliding door assembly comprising
a door guide assembly configured to define a first door guide (20a) extending along a horizontal guide axis from a first guide end (16a) to a second guide end; and
a first door arrangement assembly comprising
a respective first door assembly configured to define a first door guided by said first door guide to be guidedly movable along the guide axis, the first door extending in a vertical door plane along the guide axis; and
a respective second door assembly configured to define a second door guided by said first door guide to be guidedly movable along the guide axis independently of said first door, the second door extending in a vertical door plane along the guide axis,
wherein the first door comprises a second-end door coupler which interfaces in a direction towards the second guide end of the door guide, the second-end door coupler of said first door being configured to couple to said second door, and
the second door comprises a first-end door coupler which interfaces in a direction towards the first guide end of the door guide, the first-end door coupler of said second door being configured to couple to said second-end door coupler of said first door,
wherein the second-end door coupler (34a) of the first door and the first-end door coupler of the second door (12b) define a soft-closing mechanism configured to gradually brake a relative motion between the first and second doors along the guide axis.

2. The guided sliding door assembly according to claim 1, wherein
the first door comprises an end-stop coupler which interfaces towards the first guide end of the door guide, and
the first guide end of the first door guide comprises a first guide-end door coupler configured to couple to the end-stop coupler of said first door, wherein
the end-stop coupler of said first door and the first guide-end door coupler of the first door guide together define a soft-closing mechanism configured to gradually brake a motion of the first door along the guide axis.

3. The guided sliding door assembly according to claim 1, wherein the second door comprises a first auxiliary coupler which interfaces towards the second guide end of the door guide, the first auxiliary coupler being configured to couple to a second auxiliary coupler, wherein
the first and second auxiliary couplers define a soft-closing mechanism configured to gradually brake a relative motion along the guide axis between the second door and an object carrying the second auxiliary coupler.

4. The guided sliding door assembly according to claim 1, wherein the first door comprises
a first-end guide shuttle guided by said first door guide, and
a second-end guide shuttle guided by said first door guide.

5. The guided sliding door assembly according to claim 4, wherein the second-end door coupler of said first door is defined by the second-end guide shuttle of said first door.

6. The guided sliding door assembly according to claim 2, wherein the end-stop coupler of said first door is defined by the first-end guide shuttle of said first door.

7. The guided sliding door assembly according to claim 1, wherein the second door comprises
a first-end guide shuttle guided by said first door guide, and
a second-end guide shuttle guided by said first door guide.

8. The guided sliding door assembly according to claim 7, wherein the first-end door coupler of said second door is defined by the first-end guide shuttle of said second door.

9. The guided sliding door assembly according to claim 3, wherein the first auxiliary coupler of said second door is defined by the second-end guide shuttle of said second door.

10. The guided sliding door assembly according to claim 1, wherein the first-end door coupler of said second door defines a coupler interface of a first type, and the second-end door coupler of said first door defines a coupler interface of a second type different from the first type.

11. The guided sliding door assembly according to claim 2, wherein the end-stop coupler of said first door defines a coupler interface of one of the first and second types, and the first guide-end door coupler defines a coupler interface of the other of the first and second types.

12. The guided sliding door assembly according to claim 11, wherein the end-stop coupler of said first door defines a coupler interface of said first type, and the first guide-end door coupler defines a coupler interface of said second type.

13. The guided sliding door assembly according to claim 3, wherein the first auxiliary coupler is of said first type.

14. The guided sliding door assembly according to claim 10, wherein the coupler interface of the first type comprises a self-retractor configured to, once having engaged with a coupler interface of the second type, draw itself towards the coupler interface of the second type.

15. The guided sliding door assembly according to claim 14, wherein the self-retractor comprises a main body, and a retraction bias element coupled to an activator catcher, and the coupler interface of the second type comprises a self-retractor activator configured to engage with the activator catcher to release the retraction bias element from a pre-tensioned latch position to draw the self-retractor towards the coupler interface of the second type.

16. The guided sliding door assembly according to claim 15, wherein the activator catcher is movable relative to the main body of the self-retractor along the guide axis.

17. The guided sliding door assembly according to claim 15, wherein the activator catcher is movable against a brake bias relative to the main body of the self-retractor.

18. The guided sliding door assembly according to claim 17, wherein the brake bias is generated by a damper.

19. The guided sliding door assembly according to claim 1, wherein
the first door comprises a second-end guide shuttle guided in a shuttle guide track of said first door guide;
the second door comprises a first-end guide shuttle guided in said shuttle guide track; and
one of the second-end door coupler of said first door and the first-end door coupler of said second door comprises a coupler activator guided by a coupler activator guide track adjacent to the shuttle guide track.

20. The guided sliding door assembly according to claim 1, wherein the door guide assembly further comprises a home position connector defining a door home position at an intermediate position between the first and second guide ends, the home position connector being configured to automatically and releasably connect to at least one of said first and second doors when reaching said door home position.

21. The guided sliding door assembly according to claim 20, wherein the home position connector is configured to connect to said at least one of the first and second doors by a snap action.

22. The guided sliding door assembly according to claim 20, wherein the home position connector is configured to connect to said at least one of the first and second doors when said at least one of the first and second doors reaches the home position connector from any direction along said first guide

23. The guided sliding door assembly according to claim 22, wherein the home position connector is configured to automatically release said at least one of the first and second doors when said at least one of the first and second doors is pressed in a direction along the guide axis by a force exceeding a home position release limit force.

24. The guided sliding door assembly according to claim 23, wherein the second-end door coupler of the first door is configured to, when engaging with the first-end door coupler of the second door, attach to the first-end door coupler of the second door, and to automatically release from the first-end door coupler of the second door when the first and second doors are pressed apart along the guide axis by a disengagement force exceeding a door disengagement limit force, wherein the home position release limit force exceeds the door disengagement limit force, such that the first and second doors can be drawn apart by connecting one of the first and second doors to the home position, and moving the other of the first and second doors away from the home position.

25. The guided sliding door assembly according to claim 20, wherein the home position connector is repositionable along said guide axis to enable the home position to be axially repositioned.

26. The guided sliding door assembly according to claim 25, wherein the guide assembly defines a home position connector guide, and the home position connector comprises a home position connector clamp configured to clamp the home position connector to the home position guide.

27. The guided sliding door assembly according to claim 26, wherein the home position connector guide is defined by a home position connector guide track, and the home position connector clamp comprises an elongate clamping element extending in a direction of elongation, wherein the clamping element is
insertable, when its direction of elongation extends parallel to the home position connector guide track, into the home position connector guide track in an insertion direction perpendicular to the home position connector guide track; and
lockable to the home position connector guide track by turning the clamping element about a locking axis parallel to the insertion direction.

28. The guided sliding door assembly according to claim 1, wherein said first door guide is defined by a top guide configured to guide respective top edge portions of said first and second doors.

29. The guided sliding door assembly according to claim 1, wherein bottom edge portions of said first and second doors comprise respective support arrangements, for example wheels, configured to carry the weight of said first and second doors when moving along said first guide.

30. The guided sliding door assembly according to claim 1, wherein the first door comprises
a door leaf;
a guide shuttle guided in a shuttle guide track of said first door guide; and
a shuttle connector configured to connect the door leaf to the guide shuttle, wherein the shuttle connector is connectable to the guide shuttle when the guide shuttle is positioned in the guide track.

31. The guided sliding door assembly according to claim 1, wherein the first door comprises a door leaf;
a guide shuttle guided in a shuttle guide track of said first door guide; and
a shuttle connector configured to connect the door leaf to the guide shuttle, wherein the shuttle connector is configured to be snap-fit to the guide shuttle.

32. The guided sliding door assembly according to claim 1, wherein the first door comprises
a door leaf;
a guide shuttle guided in a shuttle guide track of said first door guide; and
a shuttle connector configured to connect the door leaf to the guide shuttle, wherein the door leaf comprises a shuttle connector guide guiding the shuttle connector along a vertical guide axis.

33. The guided sliding door assembly according to claim 1, wherein the door guide assembly is further configured to define a second door guide (20b) extending along a horizontal guide axis parallel to the first door guide, wherein the guided sliding door assembly further comprises
a second door arrangement assembly (10b) comprising
a respective first door assembly configured to define a first door guided by said second door guide,
such that the first and second door arrangement assemblies define a bypass door assembly

34. The guided sliding door assembly according to claim 32, wherein the second door arrangement further comprises a respective second door assembly configured to define a second door guided by said second door guide, wherein the second door guide is configured in accordance with the first door guide, and the first and second door assemblies of the second door arrangement assembly are configured in accordance with the first and second door assemblies of the first door arrangement assembly, as defined in claim 1.

35. The guided sliding door assembly according to claim 32 in combination with claim 20, wherein the home position connector is configured to be attached between said first and second door guides.

36. A guided sliding door assembly comprising
a door guide assembly configured to define a first door guide extending along a horizontal guide axis from a first guide end to a second guide end; and
a first door arrangement assembly comprising
a respective first door assembly configured to define a first door guided by said first door guide to be guidedly movable along the guide axis, the first door extending in a vertical door plane (P1) along the guide axis;
wherein the door guide assembly comprises
a home position connector configured to define a door home position at an intermediate position between the first and second guide ends, the home position connector being configured to automatically and releasably connect to said first door when reaching said door home position.

37. A guided sliding door assembly comprising
a door guide assembly configured to define a first door guide extending along a horizontal guide axis; and
a first door arrangement assembly comprising
a respective first door assembly configured to define a first door guided by said first door guide to be guidedly movable along the guide axis, the first door extending in a vertical door plane (P1) along the guide axis;
wherein said first door guide is defined by a top guide configured to guide a top edge portion of said first door and wherein said first door comprises
a door leaf;
a guide shuttle guided in a shuttle guide track of said first door guide; and
a shuttle connector configured to connect the door leaf to the guide shuttle, wherein the door leaf comprises a shuttle connector guide guiding the shuttle connector along a vertical guide axis (A), and wherein the shuttle connector is configured to be snap-fit to the guide shuttle.

38. A guided sliding door assembly comprising
a door guide assembly configured to define a first door guide extending along a horizontal guide axis; and
a first door arrangement assembly comprising
a respective first door assembly configured to define a first door guided by said first door guide to be guidedly movable along the guide axis, the first door extending in a vertical door plane along the guide axis, wherein said first door comprises
a door leaf (13);
a guide shuttle configured to be guided in a shuttle guide track (48a) of said first door guide; and
a shuttle connector movable in a vertical direction to connect the door leaf to the guide shuttle when the guide shuttle is positioned in the guide track.

39. The guided sliding door assembly according to claim 38, wherein the door leaf comprises a shuttle connector guide guiding the shuttle connector along a vertical guide axis.

40. The guided sliding door assembly according to claim 38, wherein said first door guide is defined by a top guide configured to guide a top edge portion of said first door.

41. The guided sliding door assembly according to claim 38, wherein the shuttle connector is configured to be snap-fit to the guide shuttle.

42. The guided sliding door assembly according to claim 37, wherein the shuttle connector is configured to enable, when connecting the door leaf to the guide shuttle, a vertical play between the door leaf and the guide shuttle.

43. The guided sliding door assembly according to claim 37, wherein the shuttle connector is configured to form an axially, with regard to the horizontal guide axis, rigid connection between the door leaf and the guide shuttle.

44. The guided sliding door assembly according to claim 37, wherein said shuttle guide track comprises a guide track opening facing in a vertical direction, wherein the shuttle connector is connectable to the guide shuttle via the guide track opening.

45. The guided sliding door assembly according to claim 37, wherein said guide shuttle is configured as a coupler forming part of a soft closing mechanism configured to gradually brake a motion of the door leaf. A method of connecting a door leaf of a sliding door to a door guide assembly comprising a top guide and a bottom guide, the door leaf comprising a bottom edge portion provided with a set of support arrangements, for example wheels, and a top edge portion provided with guide shuttle connectors configured to be connected to guide shuttles guided by the top guide, the method comprising:
positioning the support arrangements in the bottom guide;
aligning the guide shuttle connectors with the top guide; and
vertically sliding the guide shuttle connectors upwards to snap into engagement with the guide shuttles.
